(19) United States
(12) Patent Application Publication
(10) Pub. No.: US 2022/0078798 A1
(43) Pub. Date: Mar. 10, 2022

(54) RADIO FREQUENCY CONSIDERATIONS FOR BANDWIDTH PART (BWP) SELECTION

(71) Applicant: QUALCOMM Incorporated, San Diego, CA (US)

(72) Inventor: Akash KUMAR, Hyderabad (IN)

(21) Appl. No.: 17/016,166

(22) Filed: Sep. 9, 2020

(51) Int. Cl. H04W 72/08; H04W 72/04; H04L 5/00; H04W 76/27; H04W 80/02; H04W 8/18

(52) U.S. Cl. CPC H04W 72/082; H04W 72/0453; H04W 8/183; H04W 76/27; H04W 80/02; H04L 5/0092

(57) ABSTRACT

Certain aspects of the present disclosure provide techniques and apparatus for identifying one or more preferred bandwidth parts (BWPs) based on radio frequency (RF) performance degradation considerations. For example, a preferred BWP may be selected in an effort to avoid self-interference, to avoid voltage controlled oscillator pulling, to avoid thermal throttling, to enable or improve the use of multiple subscriber identification modules (MSIMs), or a combination thereof. In a general aspect, an example of the disclosed techniques by a user equipment (UE) include receiving signaling that configures the UE with a number of BWPs from a network entity, determining a preferred BWP based on an amount of RF performance degradation associated with one or more of the number of BWPs, and signaling the preferred BWP to the network entity.

### BACKGROUND

### Field of the Disclosure

Aspects of the present disclosure relate to wireless communications, and more particularly, to techniques for indicating bandwidth parts (BWPs) preferred by a user equipment (UE).

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure generally relate to an apparatus for wireless communication. The apparatus includes a memory and at least one processor coupled with the memory. The at least one processor is configured to: receive signaling configuring the UE with a plurality of bandwidth parts (BWPs); determine, from the plurality of BWPs, a preferred BWP based on an amount of radio frequency (RF) performance degradation associated with one or more of the configured plurality of BWPs; and signal the preferred BWP to a network entity.

Certain aspects of the present disclosure generally relate to a method for wireless communications that may be performed by a user equipment (UE). The method generally includes receiving signaling configuring the UE with a plurality of BWPs, determining, from the plurality of BWPs, a preferred BWP based on an amount of radio frequency (RF) performance degradation associated with one or more of the BWPs, and signaling the preferred BWP to a network entity.

Certain aspects of the present disclosure generally relate to a device for wireless communications. The device generally includes means for receiving signaling configuring the UE with a plurality of BWPs, means for determining, from the plurality of BWPs, a preferred BWP based on an amount of radio frequency (RF) performance degradation associated with one or more of the BWPs, and means for signaling the preferred BWP to a network entity.

Certain aspects of the present disclosure generally relate to a computer readable medium having instructions stored thereon for: receiving signaling that configures the UE with a plurality of bandwidth parts (BWPs); determining, from the plurality of BWPs, a preferred BWP based on an amount of radio frequency (RF) performance degradation associated with one or more of the configured plurality of BWPs; and signaling the preferred BWP to a network entity.

Aspects include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a frame format for a new radio (NR) system, in accordance with certain aspects of the present disclosure.

FIG. 7 illustrates example operations for wireless communications by a UE, in accordance with certain aspects of the present disclosure.

FIG. 8 illustrates an example preference of a bandwidth part (BWP) based on avoiding self-interference, in accordance with certain aspects of the present disclosure.

FIG. 9 illustrates an example circuit diagram related to selection of BWP based on VCO pulling avoidance, in accordance with certain aspects of the present disclosure.

FIG. 10 illustrates an example circuit diagram related to selection of BWP based on avoiding VCO pulling, in accordance with certain aspects of the present disclosure.

FIG. 11 illustrates example operations performed by a UE to select a BWP based on thermal constraints, in accordance with certain aspects of the present disclosure.

FIG. 12 illustrates an example selection of BWP for a UE having multiple subscriber identification modules (SIMs), in accordance with certain aspects of the present disclosure.

FIG. 13 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide techniques for a user equipment (UE) to select preferred bandwidth parts (BWPs) based on radio frequency (RF) considerations. As NR provides a mechanism to adaptively adjust UE operating bandwidth via the introduction of BWPs, identifying one or more BWPs preferred by the UE may help optimize configurations for efficiency and reliability.

For illustrative purposes, a UE may be allocated a subset or part of the total operating BW. BWPs may include downlink BWPs and uplink BWPs. Communication between the UE and a transmit/receive point (TRPs) occur using active BWPs. The UE may not be required to transmit or receive outside of the configured frequency range of the active BWP. The concept of active BWP improves energy efficiency.

In 5G NR, a UE can be configured with usually up to four BWPs. The network may activate one of the four BWPs for active operation at a time. Each of the four BWPs may have different parameters, such as bandwidth (BW), sub carrier spacing (SCS), and other network configurations. Based on multiple different considerations on the network side, the network may switch the UE to a specific BWP, using, for example, BWP timer based switching, downlink control information (DCI) based switching, and radio resource control (RRC) configuration or reconfiguration. Aspects of the present disclosure provide techniques to select one or more UE preferred BWPs based on certain RF considerations, in order to help avoid or mitigate performance degradation.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

### Example Wireless Communications System

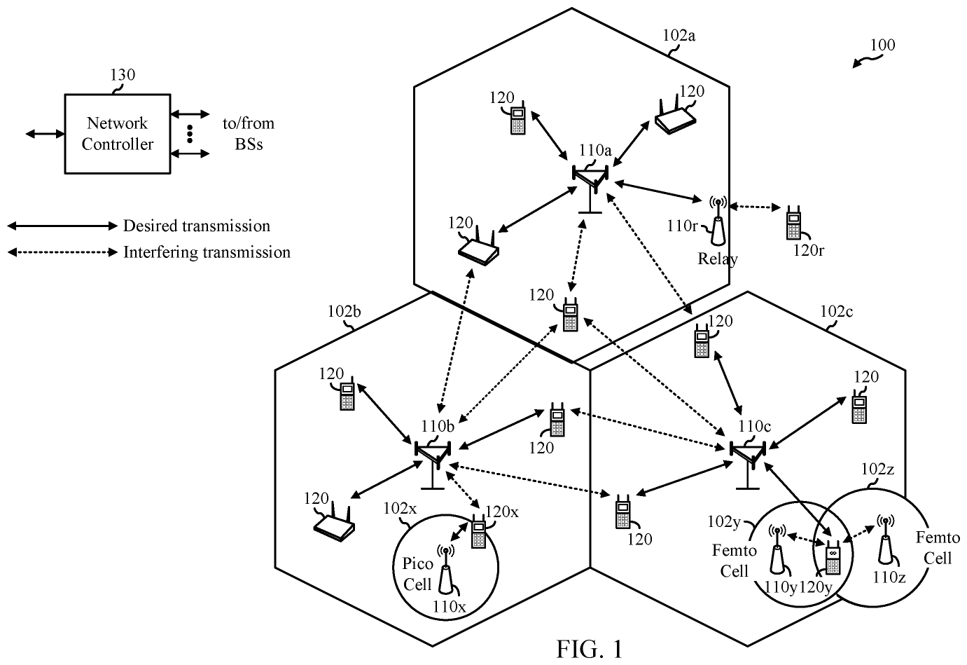

FIG. 1 illustrates an example wireless communication network 100 in which aspects of the present disclosure may be implemented. For example, the wireless network may be a new radio (NR) or 5G network. As will be described in more detail herein, a UE 120 may be configured to perform the operation 700 and other methods described herein and discussed in more detail below regarding selecting UE preferred BWPs.

As illustrated in FIG. 1, the wireless communication network 100 may include a number of base stations (BSs) 110 and other network entities. ABS 110 may comprise a transmission reception point (TRP), Node B (NB), gNB, access point (AP), new radio (NR) BS, gNodeB, 5GNB, etc.). The NR network 100 may include the central unit. The BS 110 may perform complementary operations to the operations performed by the UE.

A BS may be a station that communicates with user equipments (UEs). Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

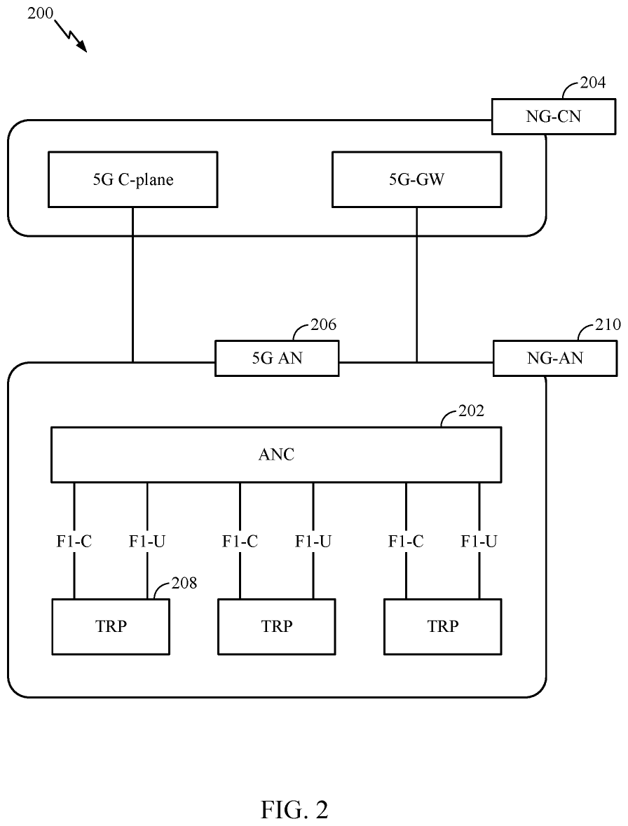

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

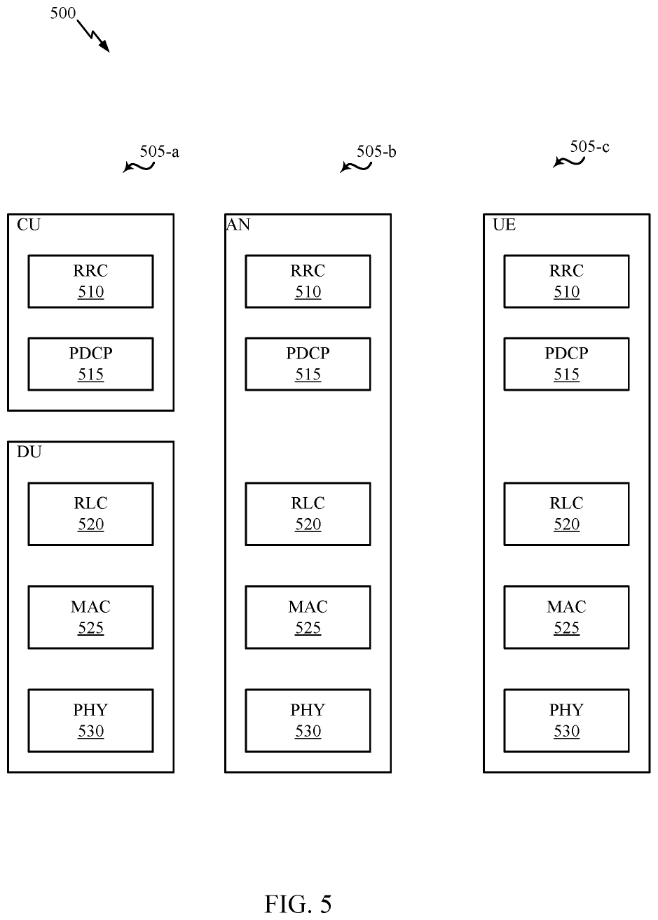

Logical functions may be dynamically distributed in the logical architecture of distributed RAN 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

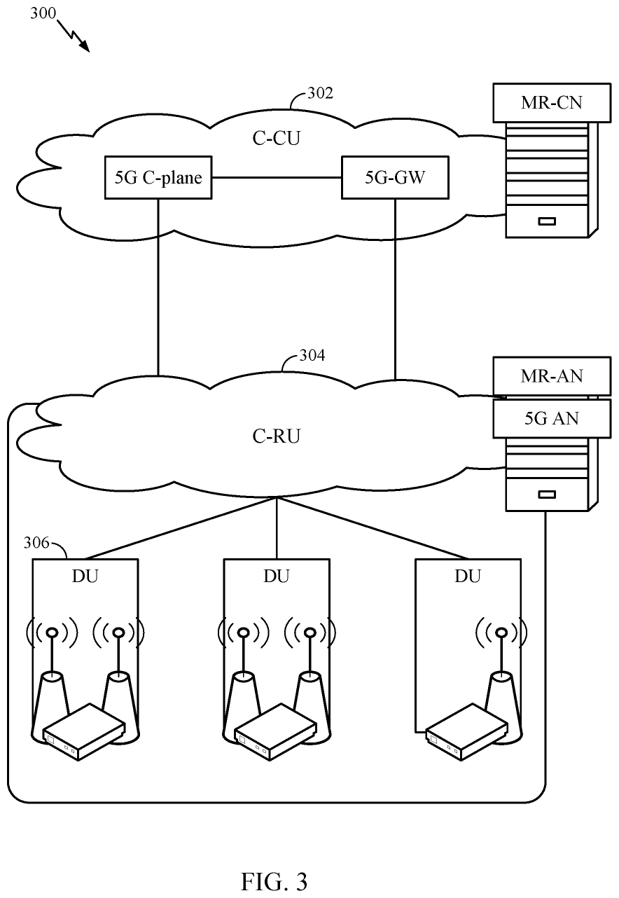

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

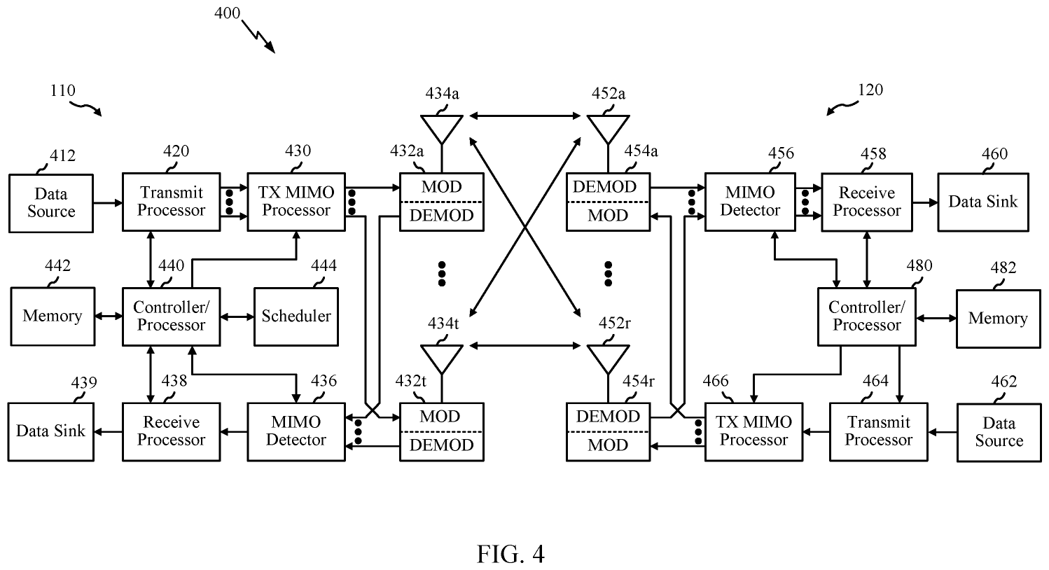

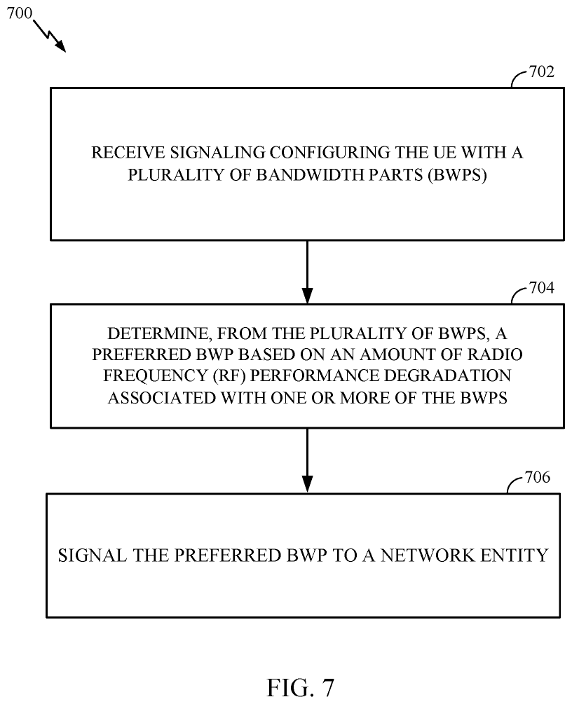

FIG. 4 illustrates example components of BS 110 and UE 120 (as depicted in FIG. 1), which may be used to implement aspects of the present disclosure. For example, antennas 452, processors 466, 458, 464, and/or controller/processor 480 of the UE 120 may be used to perform the various techniques and methods described herein and illustrated with reference to FIG. 7.

At the BS 110, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at UE 120, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the BS 110 and the UE 120, respectively. The processor 440 and/or other processors and modules at the BS 110 may perform or direct the execution of processes for the techniques described herein. The memories 442 and 482 may store data and program codes for BS 110 and UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a wireless communication system, such as a 5G system (e.g., a system that supports uplink-based mobility). Diagram 500 illustrates a communications protocol stack including a RRC layer 510, a PDCP layer 515, a RLC layer 520, a MAC layer 525, and a PHY layer 530. In various examples, the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device. In the second option, RRC layer 510, PDCP layer 515, RLC layer 520, MAC layer 525, and PHY layer 530 may each be implemented by the AN. The second option 505-b may be useful in, for example, a femto cell deployment.

Regardless of whether a network access device implements part or all of a protocol stack, a UE may implement an entire protocol stack as shown in 505-c (e.g., the RRC layer 510, the PDCP layer 515, the RLC layer 520, the MAC layer 525, and the PHY layer 530).

In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing.

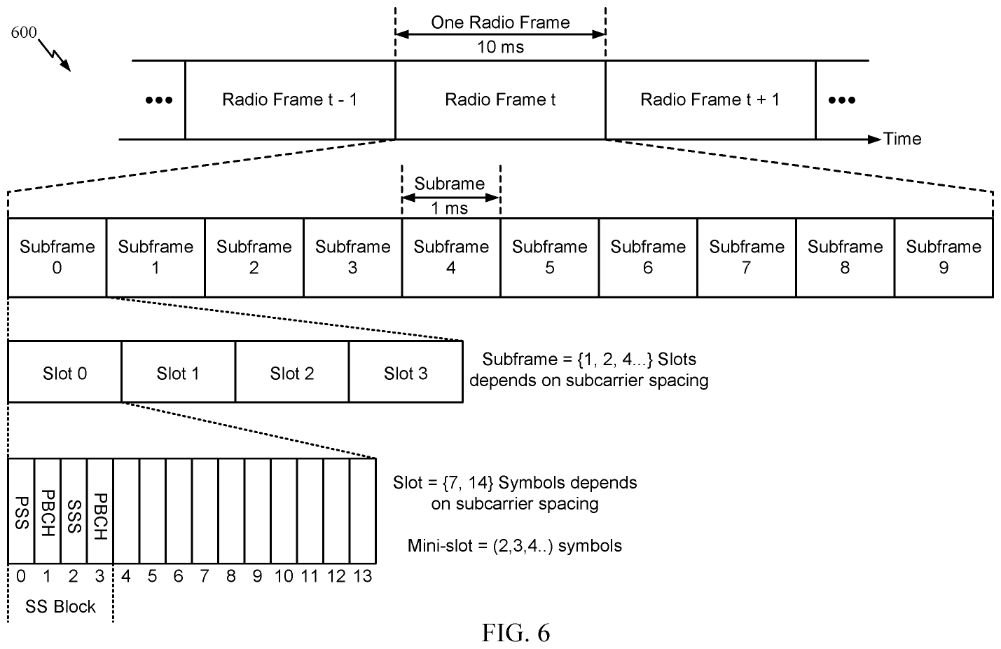

FIG. 6 is a diagram showing an example of a frame format 600 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 6. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Bandwidth Part (BWP) Selection for Multimode Devices

A multimode device may be a UE that supports two or more communication modes. For example, a multimode UE may support both LTE and 5G NR (or more). In NR, there are four BWPs available to such multimode UE. One or more of the four BWPs may be preferred in terms of efficiency, reliability, and other aspects of hardware configurations. This disclosure provides various techniques to select one or more preferred BWPs based on the RF performance degradations, in order to avoid self-interference, to avoid voltage controlled oscillator pulling, to avoid thermal throttling, to enable or improve the use of multiple SIM cards, or a combination thereof.

In a general aspect, an example of the disclosed techniques include receiving signaling that configures the UE with a number of BWPs from a network entity. The UE may determine a preferred BWP based on an amount of RF performance degradation associated with one or more of the number of BWPs. For example, the preferred BWP may be determined based on at least one of detected RF performance degradation, or predicted RF performance degradation. The UE may then signal the preferred BWP to the network entity. For example, the preferred BWP may be signaled via at least one of radio resource control (RRC) signaling, or a medium access control (MAC) control element (CE).

FIG. 7 illustrates example operations 700 for wireless communications by a UE, in accordance with certain aspects of the present disclosure. For example, operations 700 may be performed by the UE 120 of FIG. 1 or FIG. 4.

Operations 700 begin, at 702, by receiving signaling that configures the UE with a number of BWPs. At 704, the UE determines, from the configured BWPs, a preferred BWP based on an amount of RF performance degradation associated with one or more of the BWPs. At 706, the UE signals the preferred BWP to a network entity.

Various types of the RF performance degradation, that a UE may consider when selecting a preferred BWP, are discussed below.

In some aspects, determining the preferred BWP may include evaluating impact (or expected impact) of self-interference on the number of configured BWPs and selecting the preferred BWP based on the evaluation. For example, the UE may select a BWP with less impact of self-interference than one or more other BWPs as the preferred BWP. Evaluating the impact of self-interference may include dynamically monitoring a receiver while transmitting on the configured plurality of BWPs. For example, the UE may transmit on one BWP, while evaluating self-interference, and repeat this for each BWP. In some cases, in addition to, or instead of, the UE selecting a BWP of the least self-interference, the UE may request the transmitter or aggressor to alter the BWP in order to avoid RF degradation on the currently active receiver BWP. For example, the evaluation of self-interference can be used to enable both the transmitter and the receiver to identify and operate at a BWP that results in the least RF degradation in the active receiver. When either the transmit BWP (e.g., UL BWP), the receive BWP (e.g., DL BWP), or both can be chosen to minimize RF degradation, the transmit and the receive BWPs may belong to the same carrier, or different carriers in carrier aggregation (CA) mode.

In general, self-interference or self-jamming may be caused by high power transmission (e.g., up to 23 dBm) that leaks into the receiver band, despite the isolation between the transmitter (Tx) and receiver (Rx) paths. As die sizes shrink, limitations on hardware resources may result in self-interference and may present more of a challenge. For example, NR receiver may face inter mode distortion (IMD) generated by two active receivers, resulting in self-interference. Because the NR carrier supports up to 100 MHz BW and up to 400 MHz on millimeter waves, part of the carrier may not be affected by the self-interference. The BWP not impacted (or impacted the least) by self-interference is identified and selected as the preferred BWP for the carrier.

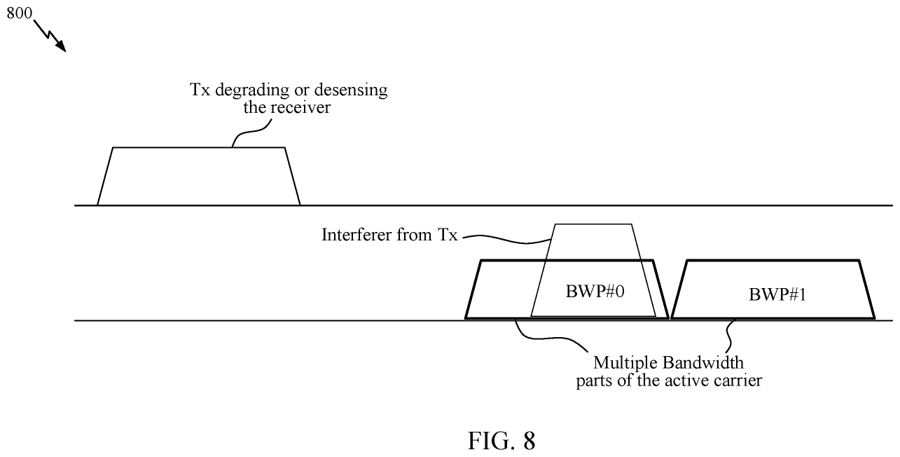

FIG. 8 illustrates example preference of BWP based on avoiding self-interference, in accordance with certain aspects of the present disclosure. As shown in FIG. 8, there are two BWPs (BWP #0 and BWP #1) in the active carrier. An active transmitter sends transmissions degrading or desensing the receiver. As a result, BWP #0 is interfered by the transmission, while BWP #1 is interference free. The UE therefore selects BWP #1 as a preferred BWP of the active carrier.

In some aspects, different techniques may be used to determine whether self-interference is occurring. In one implementation, the transmission frequencies that may cause self-interference may be measured or predetermined based on existing hardware configurations, such as active/operation frequencies of active transmitters and receivers, and harmonics of the active/operation frequencies. In another implementation, signal to noise ratio (SNR) may be monitored in real time to identify if degradation or a trend of degradation is taking place. The SNR degradation provides a dynamic benchmark for identifying self-interference. Other types of measurements/metrics may also be used to identify self-interference, such as an increase of power adjustment due to a decrease in SNR.

In some aspects, determining the preferred BWP may include evaluating center frequencies of the number of configured BWPs and selecting the preferred BWP based on the evaluation. For example, a BWP that would result in a voltage controlled oscillator (VCO) frequency that eliminates or reduces an impact of VCO pulling may be selected. When multiple phase-locked loop (PLL) or frequency oscillators are used on a same chip and tuned to similar or the same frequency, VCO pulling may occur. The VCO pulling may result in phase noise degradation, in-band spurs, frequency drift, and other performance degradation issues. These issues may lead to receiver sensitivity degradation, an increase of block error rate (BLER) in UL and DL, and a significant throughput degradation.

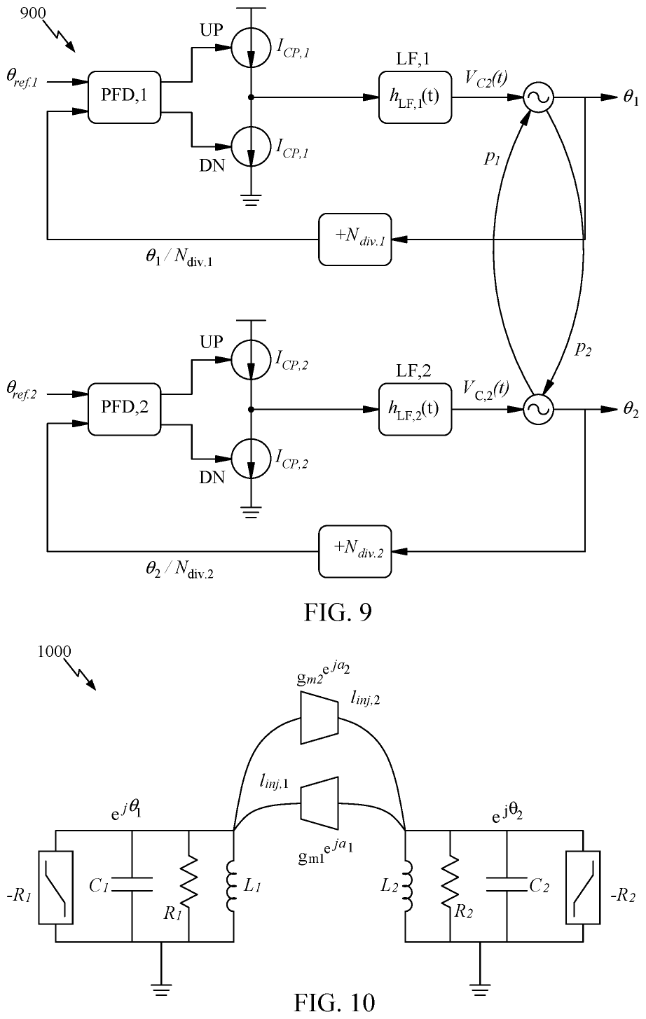

FIG. 9 illustrates an example circuit diagram related to selection of BWP based on VCO pulling avoidance, in accordance with certain aspects of the present disclosure. As shown in FIG. 9, P₁ and P₂ are coupling factors between the two oscillators of the two illustrated circuits. The coupling is a function of the difference of the frequencies of the two oscillators (e.g., the delta of f₁ and f₂). FIG. 10 illustrates an example circuit diagram related to selection of BWP based on avoiding VCO pulling, in accordance with certain aspects of the present disclosure. As shown, the voltages may be controlled and determined for the coupling shown in FIG. 9.

To minimize or avoid VCO pulling, the VCO or local oscillator may be tuned to the center of each BWP such that the center of the local oscillator changes in frequency with the center frequency of the receiver. For example, all possible sets of local oscillator or carrier frequency, as needed to operate in each of the four BWPs, may first be identified. Based on the active receivers, the frequency distance from other active receivers can be calculated. The maximum frequency distance of the four center frequencies in the four BWPs can be identified, and corresponds to the least VCO pulling. As such, the preferred BWP is selected based on the maximum frequency distance for avoiding VCO pulling.

In some cases, the consideration of avoiding self-interference and avoiding VCO pulling may be performed together. For example, a multimode UE may support non-standalone (NSA) mode and multi-subscriber-identification-module (MSIM), and support plus carrier aggregation. As a result, active VCOs exist in the UE and the VCOs may be tuned to similar frequency. For example, the UE may use MSIM from the same operator or LTE-NR in re-farmed bands, or in a co-banded intra E-UTRAN New Radio Dual Connectivity (ENDC). In such cases, a set of active Tx frequencies and Rx frequencies based on the band combination may be used to estimate self-interference. Both the self-interference and VCO pulling effect may then be estimated and weighted to select a preferred BWP that avoids or mitigates both negative effects. In some cases, active SNR monitoring may be implemented to evaluate or determine a preferred combination. For example, online metric SNR degradation may be used to select a BWP with the least amount of degradation.

In some aspects, determining the preferred BWP may be based, at least in part, on consideration of thermal constraints associated with the number of configured BWPs. In some cases, determining the preferred BWP may be based on prior information regarding thermal constraints for the configured plurality of BWPs for one or more certain UE configurations.

Due to higher bandwidths of operation in NR, the UE may be concerned with battery consumption and thermal throttling. Different BWPs may use different parameters for different configurations, and result in different levels of power consumption and thermal metrics. For example, configurations of power amplifiers, analog transceivers, clock and sampling rates, and other hardware may have specific configuration for a specific BWP. The UE may suffer from thermal throttling (e.g., hardware limiting own performance to avoid overheating) when operating in one or more of the configured plurality of BWPs. Therefore, a UE may evaluate the thermal performance corresponding to each of the four available BWPs and identify the preferred BWP that causes the least thermal throttling (and resulting in the least rate of battery consumption).

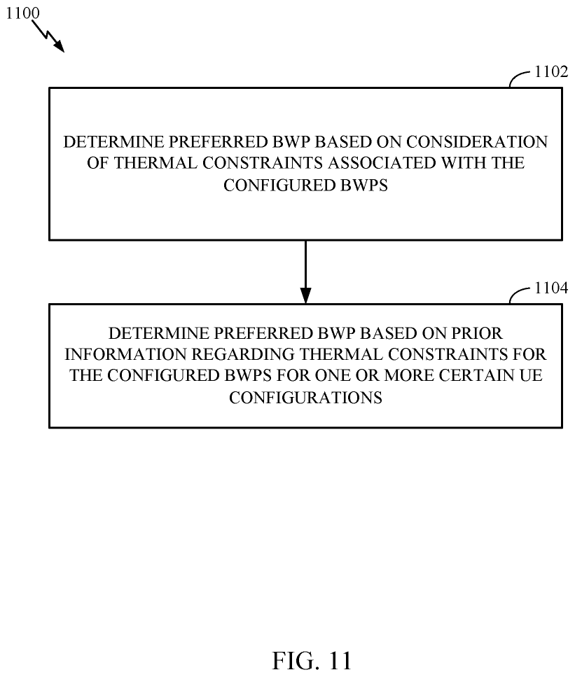

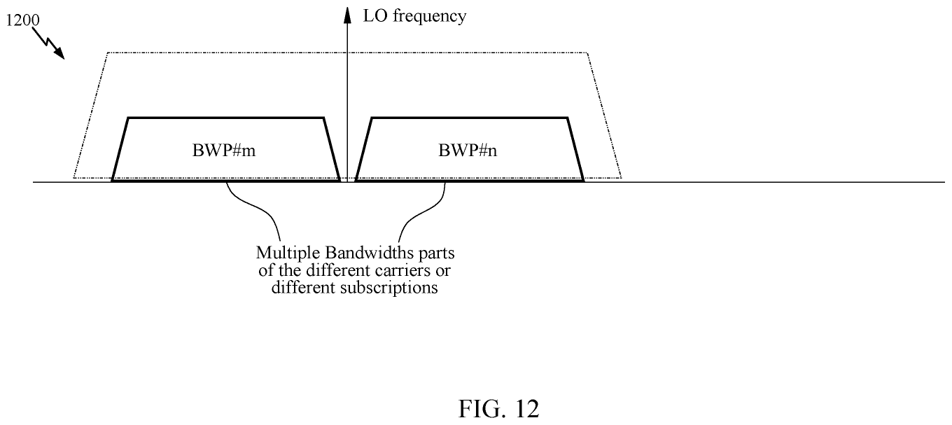

FIG. 11 illustrates example operations 1100 performed by a UE to select BWP based on thermal constraints, in accordance with certain aspects of the present disclosure. Operations 1100 begin, at 1102, by determining preferred BWP based on consideration of thermal constraints associated with the configured BWPs. For example, thermal conditions may be measured in real time, including monitoring temperatures of heat-sensitive components and the temperatures' rates of change. Thermal constraints may be imposed related to performance and stability. At 1104, the preferred BWP may be determined based on prior information regarding thermal constraints for the configured BWPs for one or more certain UE configurations. The prior information may be known thermal characteristics based on power input, temperature ratings, and other parameters pre-determined for computing thermal throttling.

In some cases, the determination of thermal throttling or battery consumption rate may be based on offline bench data. That is, the UE's thermal metric or contribution is known a priori for a certain configuration corresponding to specific BWPs, such as the frequency of operation, bandwidths, etc. For example, the off-line bench data may produce a lookup table having various operation frequencies (corresponding to BWPs) and their thermal performances.

In some cases, the determination of thermal throttling may be based on onboard sensors and real-time measurements, such as running test scenarios for each of the four BWPs to evaluate the preferred BWP that corresponds to the least thermal throttling. For example, the UE may measure the rate of power consumption of the UE, or one or more temperature readings of the hardware components of the UE, such as the power amplifier, the analog transceiver, or the processor.

In some aspects, determining the preferred BWP may include considerations for MSIM configurations. Such considerations may relate to capability of the UE to support different MSIM communication modes.

For example, in case a UE does not support dual reception on multiple subscriptions at the same time, the UE may perform a QTA/LTA to autonomously tune away the chain in use to decode the page on the IDLE sub, which causes throughput degradation or loss of synchronization with the network entity based on the gap duration. For example, in a same band class, such as B41 and N41, the frequency of operation may be very similar for the multiple subscriptions of the MSIM. There can be a specific BWP that allows the UE to operate, using the same transceiver, in both LTE's and NR's DL bandwidths of operation, for example, by increasing the bandwidth to encapsulate both bandwidths. Increasing the bandwidth this way may save the UE from tuning away and may optimize the UE's performance and throughput.

In some cases, the determining the preferred BWP is based on MSIM considerations regarding whether the UE supports at least one of simultaneous reception or simultaneous transmission on MSIMs. In some cases, the MSIM considerations may depend on certain band combinations. For example, the UE can be configured to select a preferred BWP that allows the UE to operate a same transceiver for different bands.

In some embodiments, MSIM band combination may result in an increase of bandwidth, which may be extended to NR carrier aggregation (CA) scenarios. For example, based on the right BWP selection, the UE may operate in the CA with a single receiver-transmitter chain, which also optimizes power consumption and can avoid thermal throttling. That is, the UE may be configured to select a preferred BWP that allows the UE to operate a same transceiver for different component carriers in a CA mode.

FIG. 12 illustrates example selection of BWP for a UE having multiple subscriber identification modules (MSIMs), in accordance with certain aspects of the present disclosure. As shown in FIG. 12, the BWP # m and BWP # n (indicated in solid lines) of two different carriers may be encapsulated by a larger BW (indicated in dashed lines).

The larger BW, in one example, may be determined by selecting BWP # m and BWP # n on the same subscriptions in CA and allowing the UE to tune to the center of the BWP # m and BWP # n and open a wider bandwidth to include both BWP # m and BWP # n. Similarly, the larger BW, in another example, may be determined by selecting BWP # m and BWP # n of two different subscriptions and allowing the UE to tune to the center of the BWP # m and BWP # n and open a wider bandwidth to include both BWP # m and BWP # n. For example, the analog and digital chains may be designed to support a minimum of 100 MHz of bandwidth in time to support Sub6. As such, the larger BW may be implemented without hardware changes. As such, the UE can be configured to select a preferred BWP that allows the UE to operate a same transceiver for different bands. Similarly, the UE can be configured to select a preferred BWP that allows the UE to operate a same transceiver for different component carriers in CA.

The techniques disclosed herein provide a number of methods to select a preferred BWP based on UE's operating conditions. The techniques may resolve and handle various problems related to self-interference, VCO pulling, thermal throttling, and MSIMs. The UE's preference may aid the network to activate the preferred BWP.

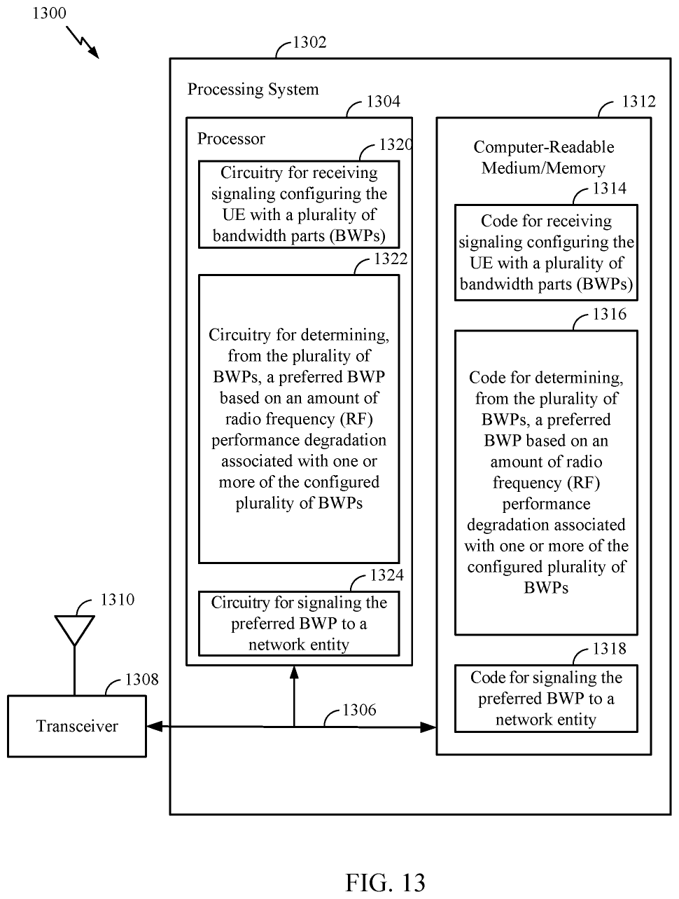

FIG. 13 illustrates a communications device 1300 that may include various components (e.g., corresponding to means-plus-function components) configured to perform operations for the techniques disclosed herein, such as the operations illustrated in FIG. 7. The communications device 1300 includes a processing system 1302 coupled to a transceiver 1308. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 7, or other operations for performing the various techniques discussed herein for BWP switching for operations. In certain aspects, computer-readable medium/memory 1312 stores code 1314 for receiving signaling configuring the UE with a plurality of bandwidth parts (BWPs); code 1316 for determining, from the plurality of BWPs, a preferred BWP based on an amount of radio frequency (RF) performance degradation associated with one or more of the BWPs; and code 1318 for signaling the preferred BWP to a network entity. In certain aspects, the processor 1004 has circuitry configured to implement the code stored in the computer-readable medium/memory 1312. The processor 1304 includes circuitry 1320 for receiving signaling configuring the UE with a plurality of bandwidth parts (BWPs); circuitry 1322 for determining, from the plurality of BWPs, a preferred BWP based on an amount of radio frequency (RF) performance degradation associated with one or more of the BWPs; and circuitry 1324 for signaling the preferred BWP to a network entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communication, comprising:
a memory; and
at least one processor coupled with the memory and configured to:
receive signaling configuring the apparatus with a plurality of bandwidth parts (BWPs);
determine, from the plurality of BWPs, a preferred BWP based on an amount of radio frequency (RF) performance degradation associated with one or more of the configured plurality of BWPs; and
signal the preferred BWP to a network entity.

2. The apparatus of claim 1, wherein the preferred BWP is determined based on at least one of detected RF performance degradation or predicted RF performance degradation.

3. The apparatus of claim 1, wherein the preferred BWP is signaled via at least one of radio resource control (RRC) signaling or a medium access control (MAC) control element (CE).

4. The apparatus of claim 1, wherein the at least one processor is configured to:
evaluate impact of self-interference on the configured plurality of BWPs; and
select the preferred BWP based on the evaluation.

5. The apparatus of claim 4, wherein a BWP with less impact of self-interference than one or more other BWPs is selected as the preferred BWP.

6. The apparatus of claim 4, wherein the evaluation comprises dynamically monitoring a receiver while transmitting on the configured plurality of BWPs.

7. The apparatus of claim 4, wherein the at least one processor is further configured to determine the preferred BWP by changing a transmit BWP to reduce RF degradation on a current receive BWP.

8. The apparatus of claim 1, wherein the at least one processor is configured to:
evaluate center frequencies of the configured plurality of BWPs; and
select the preferred BWP based on the evaluation.

9. The apparatus of claim 8, wherein selecting the preferred BWP comprises selecting a BWP that results in a voltage controlled oscillator (VCO) frequency that eliminates or reduces an impact of VCO pulling.

10. The apparatus of claim 1, wherein determining the preferred BWP is based, at least in part, on consideration of thermal constraints associated with the configured plurality of BWPs.

11. The apparatus of claim 9, wherein determining the preferred BWP is based on prior information regarding thermal constraints for the configured plurality of BWPs for one or more certain apparatus configurations.

12. The apparatus of claim 1, further comprises:
multiple subscriber identity modules (SIMs); and
wherein the at least one processor is configured to determine the preferred BWP based, at least in part, on one or more MSIM considerations.

13. The apparatus of claim 12, wherein the one or more MSIM considerations relate to capability of the apparatus to support different MSIM communications modes.

14. The apparatus of claim 13, wherein the one or more MSIM considerations comprise whether the apparatus supports at least one of simultaneous reception or simultaneous transmission on multiple SIMs.

15. The apparatus of claim 13, wherein the one or more MSIM considerations depend on certain band combinations.

16. The apparatus of claim 15, wherein the at least one processor is configured to select a preferred BWP which allows the apparatus to operate a same transceiver for different bands.

17. The apparatus of claim 15, wherein the at least one processor is configured to select a preferred BWP which allows the apparatus to operate a same transceiver for different component carriers in a carrier aggregation (CA) mode.

18. A method for wireless communications by a user equipment (UE), comprising:
receiving signaling configuring the UE with a plurality of bandwidth parts (BWPs);
determining, from the plurality of BWPs, a preferred BWP based on an amount of radio frequency (RF) performance degradation associated with one or more of the configured plurality of BWPs; and
signaling the preferred BWP to a network entity.

19. The method of claim 18, wherein the preferred BWP is determined based on at least one of detected RF performance degradation or predicted RF performance degradation.

20. The method of claim 18, wherein the preferred BWP is signaled via at least one of radio resource control (RRC) signaling or a medium access control (MAC) control element (CE).

21. The method of claim 18, wherein determining the preferred BWP comprises:
evaluating impact of self-interference on the configured plurality of BWPs; and
selecting the preferred BWP based on the evaluation.

22. The method of claim 21, wherein a BWP with less impact of self-interference than one or more other BWPs is selected as the preferred BWP.

23. The method of claim 21, wherein the evaluation comprises dynamically monitoring a receiver while transmitting on the configured plurality of BWPs.

24. The method of claim 21, wherein determining the preferred BWP comprises changing a transmit BWP to reduce RF degradation on a current receive BWP.

25. The method of claim 18, wherein determining the preferred BWP comprises:
evaluating center frequencies of the configured plurality of BWPs; and
selecting the preferred BWP based on the evaluation, wherein selecting the preferred BWP comprises selecting a BWP that results in a voltage controlled oscillator (VCO) frequency that eliminates or reduces an impact of VCO pulling.

26. The method of claim 18, wherein determining the preferred BWP is based, at least in part, on consideration of thermal constraints associated with the configured plurality of BWPs, wherein determining the preferred BWP is based on prior information regarding thermal constraints for the configured plurality of BWPs for one or more certain UE configurations.

27. The method of claim 18, wherein:
the UE supports multiple subscriber identity modules (SIMs); and
determining the preferred BWP is based, at least in part, on one or more MSIM considerations, wherein the one or more MSIM considerations relate to capability of the UE to support different MSIM communications modes.

28. The method of claim 27, wherein the one or more MSIM considerations comprise whether the UE supports at least one of simultaneous reception or simultaneous transmission on multiple SIMs.

29. A device for wireless communication, comprising:
means for receiving signaling configuring the device with a plurality of bandwidth parts (BWPs);
means for determining, from the plurality of BWPs, a preferred BWP based on an amount of radio frequency (RF) performance degradation associated with one or more of the configured plurality of BWPs; and
means for signaling the preferred BWP to a network entity.

30. A computer readable medium having instructions stored thereon for:
receiving signaling configuring a user equipment (UE) with a plurality of bandwidth parts (BWPs);
determining, from the plurality of BWPs, a preferred BWP based on an amount of radio frequency (RF) performance degradation associated with one or more of the configured plurality of BWPs; and
signaling the preferred BWP to a network entity.
